(19) United States
(12) Patent Application Publication
(10) Pub. No.: US 2014/0236392 A1
(43) Pub. Date: Aug. 21, 2014

(54) MOBILE CONTROL SYSTEM

(71) Applicant: DENSO CORPORATION, Kariya-city (JP)

(72) Inventor: Hideaki NANBA, Obu-city (JP)

(73) Assignee: DENSO CORPORATION, Kariya-city (JP)

(21) Appl. No.: 14/173,919

(22) Filed: Feb. 6, 2014

(30) Foreign Application Priority Data
Feb. 19, 2013 (JP) 2013-30272

(51) Int. Cl. F02D 41/24

(52) U.S. Cl. CPC F02D 41/24
USPC 701/2

(57) ABSTRACT

A first control signal is computed according to a first control rule, and a second control signal is computed according to a second control rule sophisticated more than the first control rule. Based on a condition of a communication between an external center and a communication module of each vehicle, any one of the first control signal and the second control signal as the control signal of an ISC valve.

### CROSS-REFERENCE TO RELATED APPLICATION

This application is based on Japanese Patent Application No. 2013-30272 filed on Feb. 19, 2013, the disclosure of which is incorporated herein by reference.

### TECHNICAL FIELD

The present disclosure relates to a mobile control system for controlling a controlled object device mounted in a mobile.

### BACKGROUND

JP-5-248291A discloses a control device for controlling an idle speed of an engine mounted in a vehicle as a mobile to a target engine speed. In the control device, a state feedback control, which is a higher-level control law than the general PID control, is conducted to improve a control performance.

In the above-mentioned feedback control, for example, a dynamic characteristic model of the engine is set in advance, a state quantity of the engine is estimated by a state observer called “observer”, and a feedback gain is determined according to a plurality of state quantities corresponding to a degree of the dynamic characteristic model of the engine to conduct the feedback control.

The above state feedback control can improve a controllability as compared with the PID control. However, on the other hand, complicated arithmetic processing for estimating the engine state quantity and determining the feedback gain needs to be conducted in real time. For this reason, a high-performance electronic control unit (ECU) that enables the complicated arithmetic processing to be executed at high speed needs to be used as an in-vehicle ECU, resulting in an increase in costs.

### SUMMARY

It is an object of the present disclosure to provide a mobile control system which can control a controlled object device according to a high-level control rule requiring complicated arithmetic processing without mounting a high-performance electronic control device in a mobile such as a vehicle.

According to the present disclosure, a mobile control system has a first control signal generation unit disposed on the mobile, and generates a first control signal according to a first control rule on the basis of information required to control the controlled object device. The mobile control system further has an external center including a communication unit that is installed outside of the mobile for conducting a data communication with the mobile, and a second control signal generation unit that generates a second control signal according to a second control rule. The second control unit is sophisticated more than the first control rule. The mobile control system further has a communication-state determination unit disposed on the mobile for determining a communication between the mobile and the external center. The mobile control system still further has a control signal switching unit which sets the second control signal as a control signal for controlling the controlled object device when the communication between the mobile and the external center is excellent. The control signal switching unit sets the first control signal generated as the control signal for controlling the controlled object device when the communication is poor.

As mentioned above, the first control signal generation unit which conducts relatively simple arithmetic processing to generate the first control signal according to the first control rule is installed in the mobile. The second control signal generation unit which needs relatively complicated arithmetic processing to generate the second control signal according to the second control rule is installed in the external center. Thus, there is no need to mount a high-performance electronic control unit in the mobile. So far as a communication between the mobile and the external center is excellent, the second control signal is used as the control signal for controlling the controlled object device. Therefore, the control performance of the controlled object device can be improved. Further, when the communication is poor, the control signal for controlling the controlled object device is switched to the first control signal. Thus, even if the second control signal cannot be correctly received from the external center due to a communication failure, a control for the controlled object device can be continued.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a configuration diagram schematically illustrating an overall configuration of a mobile control system according to an embodiment;

FIG. 2 is a configuration diagram illustrating a specific configuration of an engine;

FIG. 3 is a flowchart illustrating processing to be executed in an engine ECU;

FIG. 4 is a block diagram illustrating a method for switching a control signal of the engine ECU, and calculating a second control signal in an external center;

FIG. 5 is a diagram illustrating an example of a map for converting an intake airflow rate into a drive duty ratio; and

FIG. 6 is a diagram for explaining a connection control.

### DETAILED DESCRIPTION

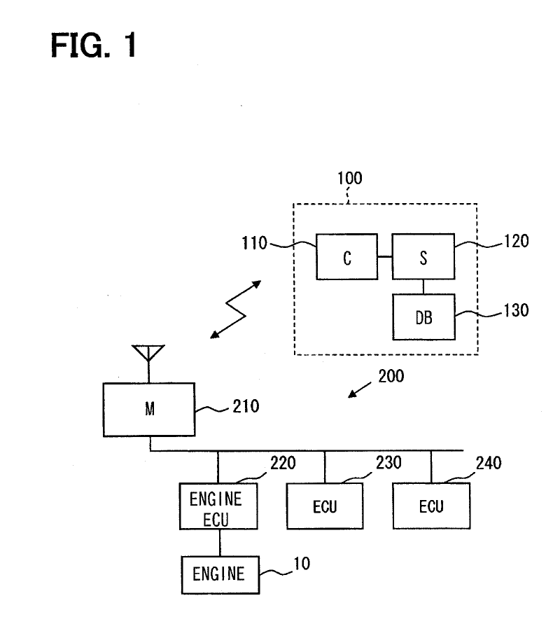

Hereinafter, an embodiment will be described with reference to the drawings. FIG. 1 is a configuration diagram schematically illustrating an overall configuration of a mobile control system. It should be noted that the present embodiment of the mobile control system is applied for controlling an idle speed of an engine of a vehicle in such a manner as to substantially agree with a target engine speed.

As shown in FIG. 1, the mobile control system mainly includes an external center 100 and an on-board control unit 200.

The external center 100 includes a communication unit 110 that conducts transmission/reception processing in cooperation with a communication module 210 for each vehicle, a server 120 that computes a second control signal for matching the idle speed of an engine 10 for each vehicle with a target engine speed. Further, the external center 100 includes a database 130 which stores a dynamic characteristic model of the engine 10 for each vehicle, and a control rule (second control rule) for conducting a state feedback control. The sever 120 corresponds to a second control signal generation unit.

The communication unit 110 receives information indicative of an engine coolant temperature, an air conditioner signal, an electric load signal, and a rotational speed of the engine from the communication module 210 for each vehicle. The rotational speed of the engine is referred to as an engine speed “Ne”, hereinafter. Based on the information, the communication unit 110 obtains the target rotational speed of the engine 10. The target rotational speed of the engine 10 is referred to as a target engine speed “rNe”, hereinafter.

It should be noted that the communication unit 110 may obtain the target engine speed “rNe” from the vehicle. Further, when the second control signal is computed by the server 120, the communication unit 110 transmits the second control signal to the communication module 210 of the corresponding vehicle.

The server 120 sets the target engine speed “rNe” at idling state on the basis of the above-mentioned various pieces of information. Further, the server 120 computes the second control signal according to the second control rule stored in the database 130 on the basis of a difference between the target engine speed “rNe” and an actual idle speed “Ne”. The server 120 controls an opening degree of an idle speed control (ISC) valve 15 according to the second control signal to execute the state feedback control. As a result, the actual idle speed “Ne” can be agreed with the target engine speed “rNe” with high accuracy.

The on-board control unit 200 includes a communication module 210 for communicating with the external center 100, and various ECUs 220 to 240 including an engine ECU 220, which are connected to the communication module 210 over a local area network (LAN). Therefore, each of the ECUs 220 to 240 can communicate with the external center 100 through the communication module 210. Also, each of the ECUs 220 to 240 can communicate with each other. The engine ECU 220 acquires the air conditioner signal, the electric load signal and the like through the communication between the respective ECUs.

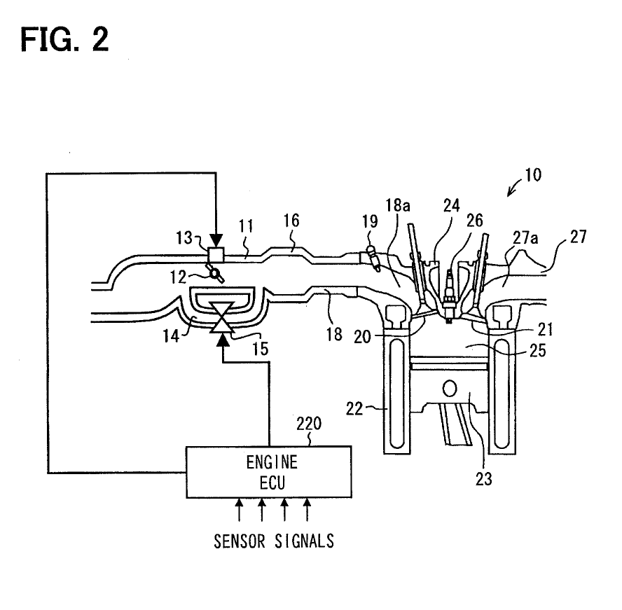

Referring to FIG. 2, a specific configuration of the engine 10 will be described. An intake pipe 11 has a most upstream portion equipped with an air cleaner (not shown). An airflow meter (not shown) for detecting an intake airflow rate in each cylinder is disposed downstream of the air cleaner. The detected intake airflow rate is transmitted to the engine ECU 220.

A throttle valve 12 adjusts a flow passage area of the intake pipe so that the intake airflow rate introduced into each cylinder is controlled. The throttle valve 12 is driven by a throttle actuator 13 such as a DC motor which is actuated according to a signal from the engine ECU 220. The intake pipe 11 has a branch passage 14 connecting an upstream portion and a downstream portion of the throttle valve 12 so as to bypass the throttle valve 12. The ISC valve 15 such as a duty solenoid valve is disposed in the branch passage 14 for adjusting the intake airflow rate flowing through the branch passage 14.

A surge tank 16 including an intake air pressure sensor (not shown) is arranged downstream of the throttle valve 12. The intake air pressure sensor detects an intake air pressure (negative pressure). An intake manifold 18 which introduces air into each cylinder of the engine 10 is connected to the surge tank 16. A fuel injector 19 is provided at a vicinity of an intake port 18a of each cylinder to inject the fuel into the cylinder. An intake valve 20 and an exhaust valve 21 are respectively provided to an intake port 18a and an exhaust port 27a of the engine 10.

A cylinder block 22 defines a cylinder and a crank case. A piston 23 connected to a crank shaft slides up and down in the cylinder. Also, an oil pan for pooling an engine oil is formed in a lower portion of the crank case. A combustion chamber 25 of each cylinder is defined by a cylinder inner wall surface, an upper end surface of the piston 23, and an inner peripheral surface of a cylinder head 24.

A spark plug 26 is disposed for each of the cylinder on a cylinder head 24 of the engine 10. The spark plug 26 receives high voltage from an ignition apparatus at a target ignition timing. The spark plug 26 generates spark between confronting electrodes to ignite the air-fuel mixture in the combustion chamber 25. A coolant temperature sensor (not shown) detecting coolant temperature is fixed on the cylinder block 22 of the engine 11.

During an operation of the engine 10, when the intake valve 20 is opened, a mixture of an injected fuel and the intake air is introduced into the combustion chamber 25. An exhaust gas after combustion is discharged into an exhaust pipe 27 through the exhaust port 27a when the exhaust valve 21 is opened.

The engine ECU 220 mainly includes a microcomputer having a CPU, a ROM, a RAM, and a backup RAM, and conducts various controls on the basis of detection values detected by the various sensors. For example, the engine ECU 220 controls a fuel injection quantity through the fuel injector 19, a throttle position of the throttle valve 12 and the ignition timing of the spark plug 26 based on the intake airflow rate detected by the airflow meter, the intake pressure detected by the intake pressure sensor, an air-fuel ratio detected by an air-fuel ratio sensor (not shown) disposed in the exhaust pipe 27 as well as an ignition signal, the engine speed, the engine coolant temperature, and an accelerator position.

The engine ECU 220 also executes an idle speed control for matching the idle speed with a target engine speed “rNe” when the engine 10 is at idling state. That is, when the engine ECU 220 determines that the engine 10 is at idling state on the basis of the throttle opening, a gear position and a starter signal, the engine ECU 220 controls the opening degree of the throttle valve 12 to a fully closed position. Further, the engine ECU 220 outputs a control signal (duty signal) to the ISC valve 15 to control the opening degree thereof.

The engine ECU 220 stores a control rule (first control rule) for conducting the PID control so as to compute a first control signal for matching the idle speed of the engine 10 with the target engine speed “rNe”. The engine ECU 220 corresponds to a first control signal generation unit. The engine ECU 220 determines the target engine speed “rNe” on the basis of a state of the engine 10, and computes the first control signal indicative of the intake airflow rate for matching the actual idle speed “Ne” with the target engine speed “rNe” according to the stored first control rule. Further, the engine ECU 220 periodically acquires a second control signal computed by the external center 100 through the communication module 210.

As above, for controlling the idle speed, the engine ECU 220 computes the first control signal according to the first control rule in which relatively small amount of computation is conducted. The external center 100 computes the second control signal according to the second control rule which is sophisticated more than the first control rule. In the second control rule, relatively large amount of computation is conducted. The engine ECU 220 holds both of the first control signal and the second control signal, and can use any control signal as a control signal of the ISC valve 15 during engine idling.

The engine ECU 220 refers to a communication between the external center 100 and the communication module 210 in order to determine which of the first control signal and the second control signal is to be used. That is, the engine ECU 220 selects any one of the first control signal and the second control signal as the control signal of the ISC valve 15 according to whether a data communication between the external center 100 and the communication module 210 is excellent or poor. Specifically, the engine ECU 220 uses the second control signal as the control signal of the ISC valve 15 so far as the data communication between the external center 100 and the communication module 210 is excellently conducted. With this configuration, the performance of the idle speed control using the ISC valve 15 can be improved. On the other hand, if the data communication between the external center 100 and the communication module 210 is poor, the engine ECU 220 switches the control signal of the ISC valve 15 from the second control signal to the first control signal. Thus, even if the engine ECU 220 cannot correctly receive the second control signal from the external center 100 due to a communication failure, the engine ECU 220 can continue the idle speed control without any trouble.

It should be noted that the first control signal and the second control signal described above represent the intake airflow rate. The engine ECU 220 converts the first control signal and the second control signal into control signals indicative of a drive duty ratio corresponding to the intake airflow rate according to the characteristic of the ISC valve 15. The converted control signals are transmitted to the ISC valve 15.

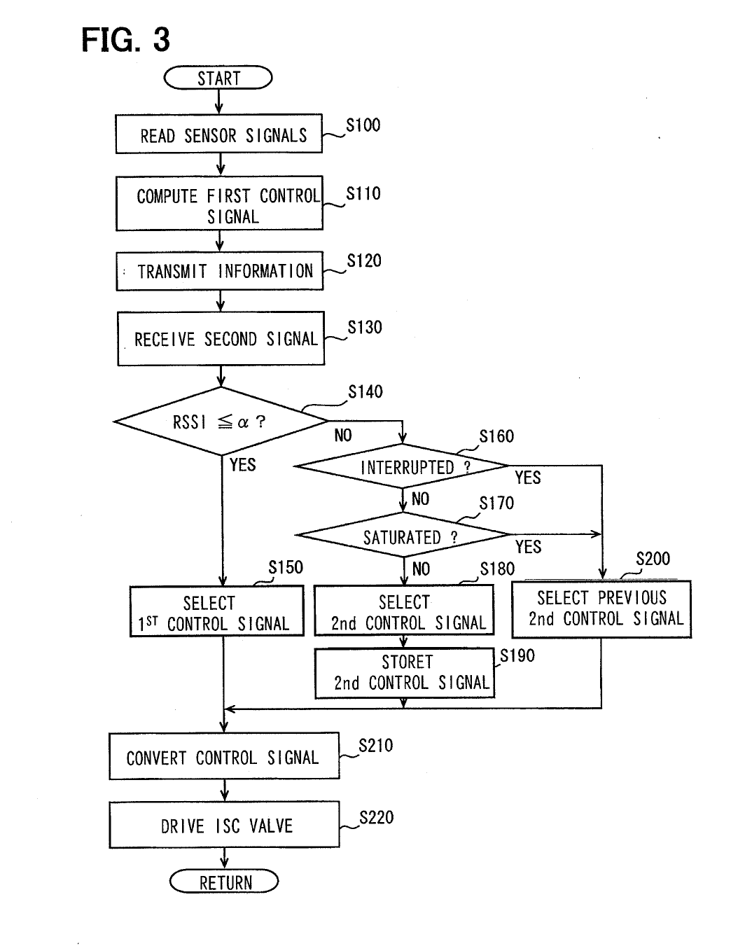

Next, a specific processing which the engine ECU 220 executes will be described with reference to FIG. 3. The processing is repeatedly executed in a given cycle when the engine 10 is at idling state.

In Step S100, the engine ECU 220 reads the sensor signals to in order to set the target engine speed “rNe” and to detect an actual idle speed “Ne”. In Step S110, the target engine speed “rNe” is set, and the first control signal is computed according to the PID control rule. For example, the first control signal u(k) indicative of the intake airflow rate is computed according to a following formula (1).

$$u ( k ) = {G}_{P} \cdot E ( k ) + {G}_{I} \cdot CE ( k ) + {G}_{D} \cdot DE ( k ) \\ wherein \\ E ( k ) = Y ( k ) - {Y}^{*} ( k ) \\ CE ( k ) = {\sum }_{k = 0}^{∞} E ( k ) \\ DE ( k ) = E ( k ) - E ( k - 1 ) \\ {G}_{P} \text{:} a proportional gain \\ {G}_{I} \text{:} an integration gain \\ GD \text{:} a differential gain \\ Y ( k ) \text{:} real idle speed \\ {Y}^{*} ( k ) \text{:} a target idle speed \qquad ( 1 )$$

The proportional gain G_{P}, the integration gain G_{I}, and the differential gain G_{D} are predetermined constants.

In Step S120, the information read in Step S100 is transmitted to the external center 100. Upon receiving the information, the external center 100 can compute the second control signal according to the second control rule.

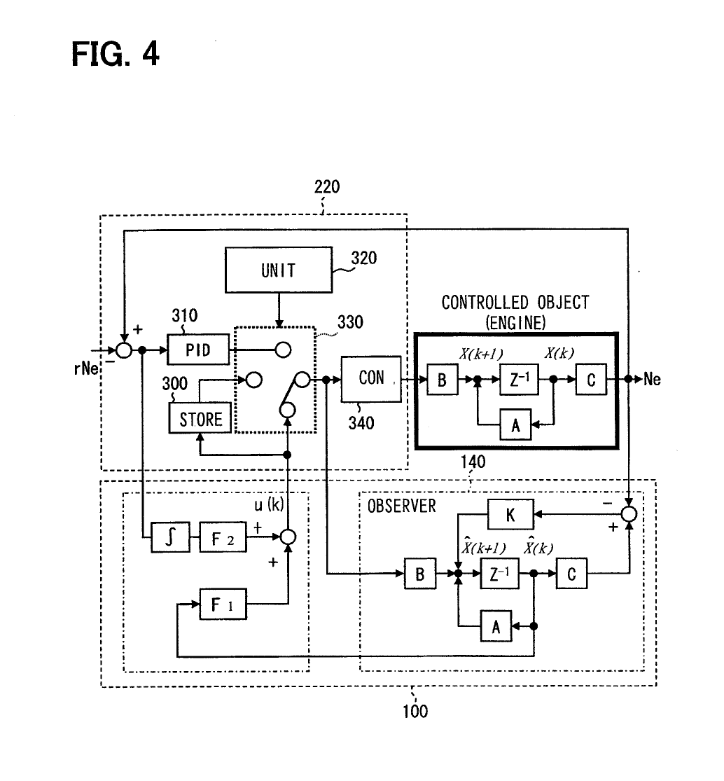

With reference to a block diagram shown in FIG. 4, a method for computing the second control signal in the external center 100 will be described.

The database 130 of the external center 100 previously stores an observer 140 including a dynamic characteristic model of the engine and a feedback gain “K”. The observer 140 includes a full-order observer and a minimal-order observer. A designing method of the above observers has been well known. In the present embodiment, any kind of observer may be used. For example, a designing method of the full-order observer will be described in brief below.

The full-order observer 140 has a configuration illustrated in FIG. 4. In the configuration of FIG. 4, an estimate value \hat{X}(k) of a state variable can be expressed as the following formula (2) by using of the feedback gain “K” and coefficients “A”, “B” and “C”.

$$\begin{matrix}\hat{X} ( k + 1 ) = A \cdot \hat{X} ( k ) + B \cdot u ( k ) + K \cdot ( Y ( k ) - \hat{Y} ( k ) ) \\ = \{ A - K \cdot C \} \hat{X} ( k ) + B \cdot u ( k ) + K \cdot Y ( k )\end{matrix} \qquad ( 2 )$$

Wherein Ŷ(k) is an estimated value of the idle speed.

In the above formula (2), it is proved that if the feedback gain “K” which stabilizes a value (A·K·C), that is, the feedback gain K in which all of absolute values of eigenvalues of a matrix that is (A·K·C) are lower than 1 is selected, \hat{K}(k)→X(k) is satisfied with k→∞. Therefore, when the feedback gain “K” is thus determined and the feedback gain “K” and the coefficients “A”, “B” and “C” are defined as the following formula (3), the above formula (2) can be represented as a following formula (4).

A₀=A−K·C

L=K

Bₙ=B (3)

\hat{X}(k+1)=A₀·\hat{X}(k)+L·Y(k)+B₀·u(k) (4)

When a state equation representing the behavior of the engine to be controlled can be represented as a formula (5), the above formula (4) represents the observer.

X(k+1)=A·X(k)+B·u(k)

Y(k)=C·X(k) (5)

Further, when a system is expanded with the use of a cumulative value for the purpose of dealing with a servo system, that is, when the system is configured by the estimated value \hat{X}(k) of the state variable estimated by the observer, and a cumulative value Z(k) of a difference between the target engine speed “rNe” and the actual idle speed “Ne”, the system can be represented by the following formula (6).

$$( \begin{matrix}X ( k ) \\ Z ( k )\end{matrix} ) = ( \begin{matrix}A & 0 \\ C & 1\end{matrix} ) ( \begin{matrix}X ( k - 1 ) \\ Z ( k - 1 )\end{matrix} ) + ( \begin{matrix}B \\ 0\end{matrix} ) u ( k - 1 ) + ( \begin{matrix}0 \\ - 1\end{matrix} ) {Y}^{*} ( k - 1 ) \\ Y ( k ) = ( C 0 ) ( \begin{matrix}X ( k ) \\ Z ( k )\end{matrix} ) \qquad ( 6 )$$

Finally, an optimal control input that minimizes an evaluation function “J” represented by the following formula (7), that is, an intake airflow rate u(k) is obtained. This is equivalent to a solution of a control problem on a loading integrating optimal regulator related to the idle speed control.

$$J = {\sum }_{k = 0}^{∞} [ {Y}^{T} ( k ) \cdot Q \cdot Y ( k ) + {u}^{T} ( k ) \cdot R \cdot u ( k ) ] \qquad ( 7 )$$

It should be noted that symbols “Q” and “R” indicate a weight parameter matrix, and “k” is the number of samplings when a control start time is 0.

Resultantly, the optimal control input u(k) is represented by a following formula (8).

u(k)=−F₁·X(k)−F₂·Z(k) (8)

“F1” and “F2” are represented by (F1 F2) R−1·BT·P, and “P” is a positive definite solution in a Riccati equation represented by the following formula (9).

S^{T}·P+P·A+Q−P·B·R⁻¹·B^{T}·P=0 (9)

The intake airflow rate u(k) is thus obtained as the optimum control input, and the ISC valve 15 is controlled to realize the intake airflow rate u(k). Thereby, the feedback control, which is so-called “state feedback”, can be conducted in view of an internal state of the engine. Thus, a response and a stability of the idle speed control can be satisfied at the same time, and the control performance can be improved.

Therefore, the optimal control input u(k) computed according to the formula (8) is supplied to the engine ECU 220. The engine ECU 220 has a storage unit 300 that stores the optimum control input u(k). A communication-state determination unit 320 determines the communication state between the external center 100 and the communication module 210. According to a determination result of the communication-state determination unit 320, a switch unit 330 selects arty one of the first control signal computed by a PID unit 310, the second control signal supplied as the optimum control input u(k) from the external center 100, and the second control signal stored in the storage unit 300, as a control signal for controlling the ISC valve 15.

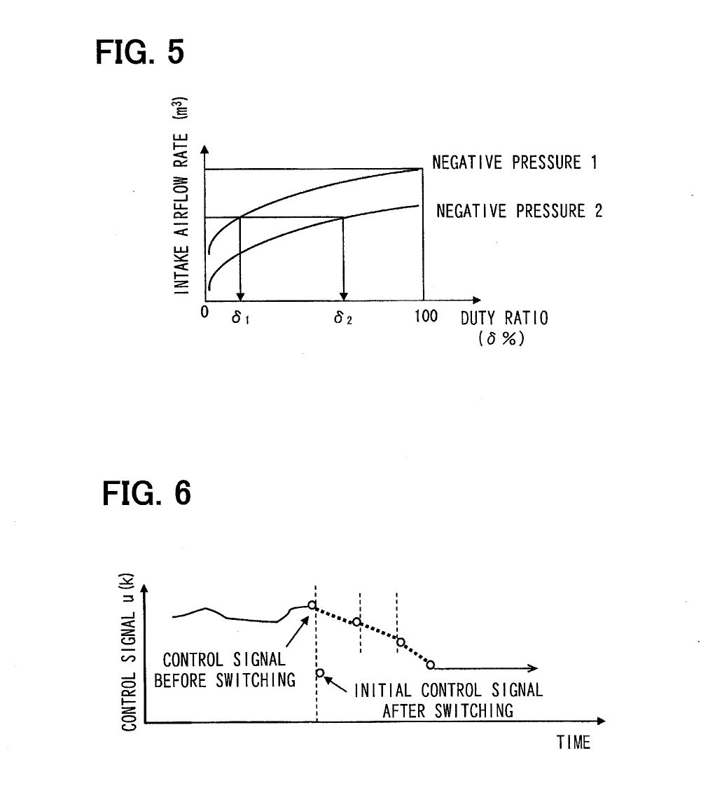

As described above, the first control signal and the second control signal are computed as the intake airflow rate. In order to set the first control signal and the second control signal as the control signal for the ISC valve 15, the intake airflow rate needs to be converted into a drive duty ratio. For this reason, a conversion unit 340 obtains the drive duty ratio corresponding to the intake airflow rate according to a negative pressure of the intake pipe 11 (surge tank 16), for example, with the use of a map illustrated in FIG. 5 to convert the control signal.

Hereinafter, a processing of switching the control signal in the engine ECU 220 according to the communication state will be described in detail with reference to the flowchart shown in FIG. 3.

In Step S130, the engine ECU 220 receives the second control signal transmitted from the external center 100 through the communication module 210.

In Step S140, the communication-state determination unit 320 of the engine ECU 220 determines whether a received signal strength indicator (RSSI) is less than or equal to a given value α when the communication module 210 receives an electric wave from the communication unit 110 in the external center 100. When the vehicle travels in a farthest area at which the electric wave arrives, or when the vehicle goes out of the farthest area, the received signal strength indicator may become equal to or lower than the given value. In this case, the engine ECU 220 is unlikely to normally receive the above-mentioned second control signal. For that reason, the procedure proceeds to Step S150 in which the first control signal computed by the engine ECU 220 is selected as the control signal of the ISC valve 15. Meanwhile, when the answer is NO in Step S140, the procedure proceeds to Step S160.

In Step S160, it is determined whether the communication between the external center 100 and the communication module 210 is suddenly interrupted even with a sufficient received signal strength indicator. For example, when a noise source (another vehicle) that generates an electric wave causing a noise is present in the vicinity of the vehicle, the communication may be suddenly interrupted due to an interference with the electric wave causing the noise. Also, if the vehicle enters a shadow of buildings that blocks the electric wave, the communication may be suddenly interrupted. In those cases, it is conceivable that the vehicle travels to immediately return the communication between the external center 100 and the communication module 210. Therefore, the switching to the first control signal is not conducted, but the procedure proceeds to Step S200 in which the stored second control signal used in the previous control is again employed as the control signal of the ISC valve 15. Meanwhile, when the answer is NO in Step S160, the procedure proceeds to Step S170.

In Step S170, the engine ECU 220 determines whether the received signal strength indicator reaches a saturated level. When the received signal strength indicator is very high, a receiver circuit receiving and decoding the electric wave may be saturated, so that the receiver circuit does not function. Since it is assumed that such a situation occurs when a plurality of vehicles is congested, the situation may be frequently eliminated by travel of the vehicles. Thus, when it is determined in Step S170 that the received signal strength indicator reaches the saturation level and the communication between the external center 100 and the communication module 210 is saturated, the procedure proceeds to Step S200 in which the previous stored second control signal is selected. Meanwhile, when the answer is NO in Step S170, the procedure proceeds to Step S180.

In Step S180, the engine ECU 220 selects the second control signal as the control signal of the ISC valve 15. In Step S190, the engine ECU 220 stores the second control signal to prepare for the communication interruption or an increase of the received signal strength indicator to the saturation level, that is, the communication between the external center 100 and the communication module 210 is saturated.

In Step S210, the selected control signal indicative of the intake airflow rate is converted into a control signal indicative of a drive duty ratio. In Step S220, the ISC valve 15 is driven by the converted control signal.

In the above-mentioned embodiment, both of the first control signal and the second control signal are computed by the engine ECU 220 and the external center 100 while the engine 10 is at idling state, without respect to which control signal is really used in the idle speed control. Therefore, even when the control signal is switched between the first control signal and the second control signal, a large gap hardly occurs between the respective control signals. That is, the first control signal is computed according to the PID control rule including an integral item, and the second control signal is computed according to the state feedback control in view of the internal state of the engine. Thus, even if the first control signal and the second control signal are different from each other at a certain time point, the difference is reduced with time.

It should be noted that both of the first control signal and the second control signal may not be always computed. For example, when it is determined according to the received signal strength indicator that the second control signal is unlikely to be switched to the first control signal, the computation of the first control signal may stop. Even in this case, the first control signal is computed when the received signal strength indicator is lowered so that the second control signal is likely to be switched to the first control signal. As a result, the first control signal can be computed before the control signal is actually switched to another. Likewise, when the received signal strength indicator is remarkably low, that is, when the communication between the external center 100 and the communication module 210 is poor, the calculation of the second control signal may be stopped. Then, when the received signal strength indicator increases and the first control signal can be switched to the second control signal, the second control signal may be computed.

Also, when the first control signal and the second control signal are not computed at the same time, or when a gap between the control signals before and after switching, it is preferable that the engine ECU 220 executes a connection control described below. When the gap between the control signals before and after switching is large, the idle speed is varied due to switching. The ECU 220 functions as a connection control unit.

An outline of the connection control is illustrated in FIG. 6. The engine ECU 220 computes the gap between a control value (intake airflow rate) of the control signal before switching and an initial value (intake airflow rate) of the control signal after switching. When the engine ECU 220 determines that the gap is greater than or equal to a specified value, the engine ECU 220 computes connection control values (intake airflow rate) that allow the control value before switching to approximate the initial value after switching. After the engine ECU 220 outputs all of the connection control values as the control signals of the ISC valve 15, the engine ECU 220 switches the control signal to another.

The present disclosure should not be limited to the disclosed embodiment, but may be implemented in other way without departing from the sprit of the disclosure.

For example, in the above-mentioned embodiment, the stored second control signal is used as the control signal for controlling the ISC valve 15 when the communication is interrupted or the received signal strength indicator reaches the saturation level is saturated even if the received signal strength indicator is higher than the given value. However, as the control signal used in this situation, not the stored second control signal, but a control signal indicative of a predetermined constant intake airflow rate may be employed. For example, a normal intake airflow rate at idling state of the engine is experimentally obtained, and a constant control signal indicative of the obtained intake airflow rate may be used.

Also, in the above embodiment, the mobile control system is applied for controlling the idle speed of the engine. However, the mobile control system is not limited to the above example. For example, the mobile control system may be applied for controlling the engine at normal operating state. In this case, the target engine speed “rNe” is replaced with a target torque, and an object to be controlled is the throttle valve opening. Further, the mobile control system may be applied for controlling another device (an air conditioner, a brake system, an air bag, etc.) other than the engine. Moreover, the mobile control system may be applied for controlling a device mounted in a mobile such as an air plane, other than the vehicle.

In the above mentioned embodiment, the engine ECU 220 computes the first control signal under the PID control rule, and the external center 100 computes the second control signal under the state feedback control rule. However, the control rule for calculating the control signal in the mobile, and the control rule for calculating the control signal in the external center 100 are not limited to the PID control rule. For example, the control rule using any combination of PID such as PI and PD may be applied in the mobile. Further, as described above, a constant value or the stored value of the second control signal may be used as the first control signal. Further, in the external center 100, the second control signal may be computed under a control rule using a H∞ control theory, or a sampled value control theory. In short, a configuration in which the first control signal is computed under the easier control rule in the mobile, and the second control signal is computed under the more sophisticated and complicated control rule in the external center falls within the scope of the present disclosure.

What is claimed is:

1. A mobile control system for controlling a controlled object device mounted in a mobile, comprising:
a first control signal generation unit disposed on the mobile, the first control signal generation unit generating a first control signal according to a first control rule based on an information required to control the controlled object device;
an external center including a communication unit installed outside of the mobile, the external center conducting a data communication with the mobile, the external center having a second control signal generation unit which generating a second control signal according to a second control rule sophisticated more than the first control rule based on the information required to control the controlled object device;
a communication-state determination unit disposed on the mobile, the communication-state determination unit determining a state of a communication between the mobile and the external center; and
a control signal switching unit setting the second control signal as a control signal for controlling the controlled object device when the state of the communication between the mobile and the external center is excellent, the control signal switching unit setting the first control signal as the control signal for controlling the controlled object device when the state of the communication between the mobile and the external center is poor.

2. A mobile control system according to claim 1, wherein
when the control signal switching unit switches the control signal between the first control signal and the second control signal, the first control signal generation unit or the second control signal generation unit generates the first control signal or the second control signal under the first control rule or the second control rule before the control signal is switched therebetween.

3. A mobile control system according to claim 2, wherein
the first control signal generation unit always generates the first control signal while the second control signal is set as the control signal for controlling the controlled object device.

4. A mobile control system according to claim 1, wherein
the control signal switching unit includes a connection control unit executing a connection control, and
when a difference between a last value of the control signal before switching and an initial value of the control signal after switching is higher than or equal to a given value, the connection control unit computes a value of the control signal in such a manner that a last value of the control signal before switching and an initial value of the control signal after switching are approximated to each other.

5. A mobile control system according to claim 1, wherein
the communication-state determination unit determines that the communication between the mobile and the external center is poor when a signal power from the external center is lower than or equal to a given value, so that the second control signal is switched to a first control signal.

6. A mobile control system according to claim 1, wherein
when it is determined that the communication between the mobile and the external center is temporarily interrupted, the second control signal that has been already acquired from the external center is used as the control signal for controlling the controlled object device.

7. A mobile control system according to claim 1, wherein
when it is determined that the communication between the mobile and the external center is temporarily interrupted, a predetermined control signal is used as the control signal for controlling the controlled object device.

8. A mobile control system according to claim 1, wherein
when it is determined that the communication between the mobile and the external center is saturated, the second control signal that has been already acquired from the external center is used as the control signal for controlling the controlled object device.

9. A mobile control system according to claim 1, wherein
when it is determined that the communication between the mobile and the external center is saturated, a predetermined control signal is used as the control signal for controlling the controlled object device.
